(19) United States
(12) Patent Application Publication
(10) Pub. No.: US 2008/0243605 A1
(43) Pub. Date: Oct. 2, 2008

(54) MARKETING AND REWARDS SYSTEM AND METHOD

(76) Inventor: Paul Burger, Thousand Oaks, CA (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/693,217

(22) Filed: Mar. 29, 2007

(51) Int. Cl. G06Q 30/00

(52) U.S. Cl. 705/14

(57) ABSTRACT

Exemplary embodiments may include a system and method for marketing and rewards for users, who may be lenders, realtors, and from other regional or Internet businesses and their employees, to induce a user to use the services of a particular lender, realtor, or other business. Other embodiments may include a method and system for viral-type marketing.

### CROSS REFERENCE TO RELATED APPLICATIONS

This application is a continuation in part of application Ser. No. 10/950,256, entitled “Methods and System for Marketing Rewards,” which is incorporated herein for all purposes.

### BACKGROUND

Buying a home, refinancing, and home improvement may be times in which a person spends the most money in a short period of time in their lifetime. The largest expense to homebuyers and sellers, and refinancing may be the realtor fees and mortgage origination costs, among others. Many companies and brokers offer services that may include real estate and mortgage services.

When people move into a new city or area, they may have to find a new doctor, dentist, grocery store, cleaners, etc. It may be advantageous to offer savings by other businesses via a group arrangement to influence them to utilize a particular lender, realtor or other business. More people may use the service of a lender, realtor, or other business if they were offered discounts and/or other incentives on fees from the lender, realtor, or other business, and/or discounts from regional, national, and/or international businesses.

### SUMMARY

Exemplary embodiments of the present invention may include a marketing and rewards system and method for offering marketing and rewards to consumers from lenders, realtors, and from other regional businesses and their employees and friends to influence a consumer to use the services of a particular lender, realtor, or other business.

### BRIEF DESCRIPTION OF THE DRAWINGS

FIG. 1 is a block diagram of a method for setting up a team, according to an embodiment.

FIG. 2 is a block diagram of a method of a transaction, according to an embodiment.

FIG. 3 is a block diagram of a method of viral-type marketing, according to an embodiment.

FIG. 4 is a block diagram of a system capable of implementing marketing and rewards systems and methods, according to an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description that follows are presented in terms of processes, programs and/or symbolic representations of operations on data bits and/or binary digital signals within a computer memory, for example. These process descriptions and/or representations may include techniques used in the data processing arts to convey the arrangement of a computer system and/or other information handling system to operate according to such programs, processes, and/or symbolic representations of operations.

A process may be generally considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It may be convenient at times, principally for reasons of common usage, to refer to these signals as bits, values, elements, symbols, characters, terms, numbers and/or the like. However, these and/or similar terms may be associated with the appropriate physical quantities, and are merely convenient labels applied to these quantities.

Embodiments claimed may include one or more apparatuses for performing the operations herein. Such an apparatus may be specially constructed for the desired purposes, or it may comprise a general purpose computing device selectively activated and/or reconfigured by a program stored in the device. Such a program may be stored on a storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and/or programmable read only memories (EEPROMs), flash memory, magnetic and/or optical cards, and/or any other type of media suitable for storing electronic instructions, and/or capable of being coupled to a system bus for a computing device, computing platform, and/or other information handling system. However, the computer program product may also be capable of being downloaded directly to the computing device, such as, but not limited to, a download over the Internet. This disclosure is intended to cover this carrier wave format.

The processes and/or displays presented herein are not inherently related to any particular computing device and/or other apparatus. Various general purpose systems may be used with programs in accordance with the teachings herein, or a more specialized apparatus may be constructed to perform the desired method. The desired structure for a variety of these systems will appear from the description below. In addition, embodiments are not described with reference to any particular programming language. It will be appreciated that a variety of programming languages may be used to implement the teachings described herein.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. Furthermore, couple may mean that two objects are in communication with each other, and/or communicate with each other, such as two pieces of software, and/or hardware, or combinations thereof. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

The detailed description set forth below in connection with the appended drawings are intended as a description of embodiments and are not intended to represent the only forms in which the embodiments may be constructed and/or utilized. The description also sets forth the functions and the sequence of steps for constructing and operating the embodiments in connection with the illustrated embodiments. However, it is to be understood that the same or equivalent functions and sequences may be accomplished by different embodiments that are also intended to be encompassed within the spirit and scope of this disclosure.

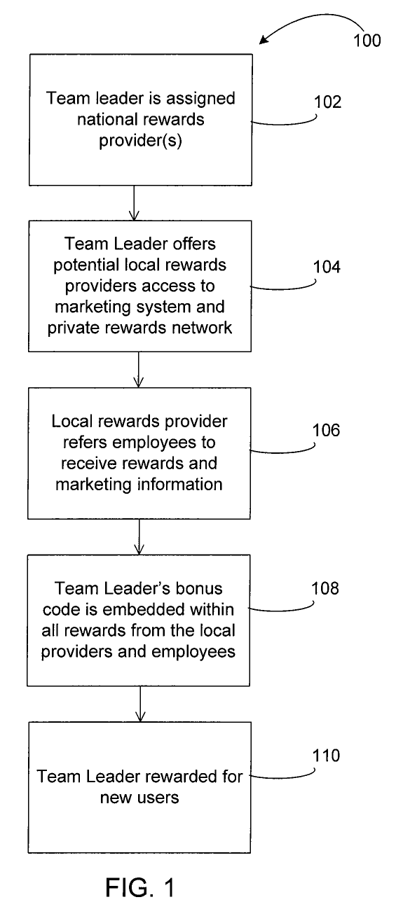

A method for marketing and/or rewards according to one exemplary embodiment is shown in FIG. 1, generally at 100. In an embodiment, system 100 may include the team leader being initially given one or more national rewards providers 102, the team leader offering potential local rewards providers access to marketing system and private reward networks 104 and local rewards providers referring employees to receive rewards, discounts on mortgage and various other real estate services, and marketing information 106. Furthermore, system 100 may include the team leader's bonus code being visually imbedded within all rewards coupons and utilized users, and the team leader being rewarded for business originated 110.

Once the team leader has requested to be included within the system, the team leader is relatively automatically provided with national rewards providers 102. The team leader is then allowed to utilize the rewards from the national rewards providers, as well as offer those rewards to other potential team leaders to induce them to use the system. The referring team leader may be compensated for bringing more users to the system.

In an embodiment, the team leader may offer potential local rewards providers access and discounts on mortgage and various other real estate services to the marketing system, and to the private rewards network 104. The access to the marketing system may allow businesses and/or rewards providers a module to create and manage their marketing. This may be online and/or other marketing systems. Furthermore, the system may include a coupon creator, reward tracker, and/or other functionality.

In an embodiment, a local rewards provider may refer their employees to receive rewards and discounts on mortgage and various other real estate services, and marketing information at 106. The employees may then be able to access the rewards system to utilize rewards and/or coupons from the local and/or national rewards providers. The employees may then be included in the marketing system and may receive periodic marketing materials. In this manner, team leaders may refer friends/business prospects to the network to allow them to be included in the marketing system, as well as receive rewards from the private network and/or national rewards providers. New users/prospects may be employees, customers, friends, acquaintances, etc. A team leader may include virtually anyone in the system.

In an embodiment, team leaders may only be real estate professionals, and may only provide bonus dollars. In an embodiment, rewards providers may only be businesses/business owners. In an embodiment, users/friends/prospects may only be persons receiving access to the rewards. In an embodiment, a user is any person or entity authorized to user the system, and may be any or all, and/or combinations of those described herein. In an embodiment, a prospect may be anyone who may want to utilize the system, and/or the services of a team leader.

The team leader's bonus code may be embedded within all rewards coupons printed, and all email correspondence from the team leader to the local providers and employees at 108. This will allow the system to track the customers/prospects and/or other business and/or entities referred to the system by the team leader.

This may allow the team leader to receive compensation when new users pay to use the system at 110. The team leader may be compensated for the number of other users paying a monthly fee to use the system. As can be seen, a team leader may refer another team leader to the system. In this embodiment, a referring team leader may receive a percentage of the amount the referred team leader pays to utilize the system. A referring team leader may then sign up a sufficient number of other team leaders to offset the cost of utilizing the system.

In an embodiment, only a real estate professional may be a team leader. A team leader may offer bonus dollars to be used as a discount off regularly priced services from the team leader or other team leaders. Furthermore, in an embodiment, a team leader will make money when a user uses the team leader's services, and/or when they get a percentage of fees from other referred team leaders fee payments.

Once a team leader signs up, they may be assigned national rewards providers. They may also induce other local businesses to become local rewards providers, and the local businesses may then refer their employees to the system. The team leader receives access to the marketing system, which would allow them to manage their online and/or marketing rewards, as well as entire marketing for the company. The team leader may also provide bonus dollars, which may further induce users to utilize the team leader's services.

In an embodiment, once a prospect utilizes the system, they will be asked for the bonus code from the team leader, unless they clicked on an email sent by the team leader, which includes the imbedded bonus code. When the user is provided with a list of different services they may receive bonus dollars from, the team leader that gave them the bonus code may be the only service provider in a particular category of services, such that the team leaders may be induced to sign up more users, as the team leader may then be the only service provider in a particular service category.

In another embodiment, if a user does not have a bonus code when they utilize the rewards system, they may be provided with a list of all team leaders. The team leaders may be charged a flat, monthly fee to utilize the system, which may be offset from the compensation for other referred team leaders paying to use the system.

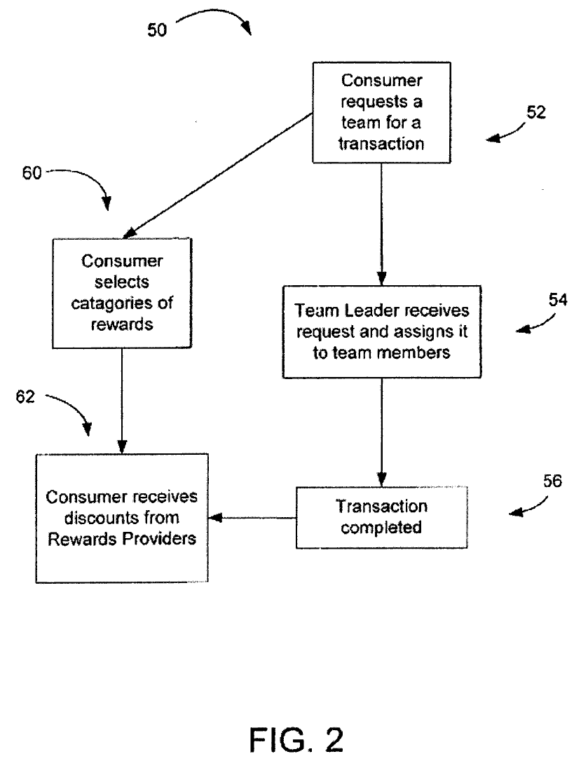

FIG. 2 is a transaction method according to an exemplary embodiment, generally at 50. Method 50 may include the customer requesting a team for a transaction, at 52. The consumer may go online to a website to facilitate this, however, it will be appreciated that other avenues may be utilized to accomplish this activity. After the consumer requests a team for a transaction at 52, the team leader may receive the request for the services requested by the customer. Typically, this may occur via e-mail or other methods, as desired. The team leader receives the request and may assign different team members to that request based upon the particular transaction requested by the customer.

Method 50 also may include the transaction being completed at 56. This may be when the mortgage closes, when the refinance is funded, or other transaction-ending event. Once the transaction is completed, some and/or all of the transaction team members who participated in the successful transaction may pay a relatively small fee to the system provider. Alternatively, the provider of the system may also charge the team leader and/or some and/or all team members and/or transaction team members a fixed monthly or yearly fee to utilize the system, as desired.

Method 50 may include the consumer selecting categories for the discounts that they are interested in, at 60. The consumer may select general areas of discounts they may be interested in, in their regional area. These general areas may include, but not be limited to, home improvement, dining, cleaners, lawn care, dentists, health care, hair styling, and the like. The consumer may then be informed about the amount of discounts available for each of these categories, selected by the consumer when the consumer initially requests services, such that a consumer may be more likely to utilize the services of the team rather than assembling their own group of professionals for a particular transaction.

Once the consumer has selected the categories and the transaction is completed, the consumer may receive the discounts from the rewards providers, at 62. This may be accomplished with a code via the Internet somewhat automatically, however, other methods and configurations may be utilized, as desired. In an alternative embodiment, a team leader may allow a user to access the rewards by adding the user to the marketing system. The consumer may know from which rewards providers the discounts will come, but may not know the details of the discount or incentive until the transaction closes. This may protect the rewards provider from pricing conflicts with their regular retail clients.

Discounts and incentives provided by each rewards provider may vary from time to time, as determined by the rewards provider, as long as the total amount offered remains above a predetermined amount for a particular team area. It may be important that the rewards providers provide a discount or incentive that they do not offer to the general public, such that a consumer may be more likely to utilize the services of the team rather than assembling their own group of professionals for the real estate, or other transaction.

In an embodiment, when the consumer redeems the coupon through the system, the reward coupon, with the consumer name only, a date and time stamp, and team leader information may be embedded in the coupon and electronically sent to the rewards provider, such that the rewards provider will be informed that a particular coupon has been activated, by whom, and which team leader sent the potential customer. This may decrease the likelihood of fraudulent coupons and help the rewards provider better track their advertising and promotions.

In an embodiment, the discounts may be in the form of printable coupons. When a coupon is printed, it may include a time stamp, user identification, and/or other information, and/or combinations thereof. Furthermore, the provider may be sent a notification, such as an email, notifying them that a particular reward coupon has been printed, along with the user identification and/or other information. In this manner, a rewards provider may better plan for sales and/or utilization of particular rewards coupons. The notification may also include a representation of the coupon that was printed by the user. This may assist the rewards provider in detecting and somewhat reducing fraudulent coupons.

With this system and method, team members and team leaders may be more likely to utilize the system as it may be of minimal or no cost until after they have made money, or the fixed fee charged may be relatively small in comparison to the amount of business that the system may attract.

Similarly, rewards providers may manage their own coupons, discounts, and advertising themselves, thereby saving money. Furthermore, the rewards providers may make up their own printable coupons utilizing the system, thereby saving printing and design costs. The consumer may save money on discounts from the transaction team, as well as the discounts from the rewards providers. In an embodiment, the discounts may be in the form of bonus dollars that the user may utilize with any and/or all of the transaction team.

Therefore, with this system, everyone involved is more likely to utilize the system and team to increase business, revenue, and business leads. Everyone involved may make money, which may make everyone relatively more satisfied.

In an embodiment, an upload module may be utilized to allow the rewards provider to create, view, activate, and/or generally control the rewards/coupons. This may better allow a rewards provider to control their own marketing, while allowing them to utilize a tool to create and manage their marketing rewards.

Rewards providers may be regional to the area in which the team leader has been granted. However, rewards providers that have a strong Internet or other presence in the area may also be considered. In this manner, the rewards provider may be able to increase business by having more consumers utilize their business, or services. This system will also enable team leaders to generate their own business leads in a new way, such that they may not be dependant upon real estate agents, realtors, and the like, for business contacts and/or leads.

In an embodiment, the team members need not pay any money until the transaction closes, and may also offer discounts on their services for the transaction. Therefore, the team members may also enter a team while spending little or no money until the transaction closes, which may entice them to join teams more readily. In another embodiment, the team leaders may be charged a monthly fee for utilization of the system.

In an embodiment, the system provider may provide the system and method for the teams and rewards providers to better conduct business. The team leader, and/or team members may not need pay any up front costs, have no capital expenditures, and need no new equipment to utilize the system. The system may already be in place for team members to utilize, on a small fixed fee basis.

The categories for rewards providers may include sports, entertainment and leisure, kids and family, food and beverage, computers and electronics, apparel and fashion, home and garden, gifts and flowers, books and music, office and business, new cars and trucks, health and beauty, among others, as desired. The consumer may select more categories if more team services are utilized, such as loan, real estate selling, real estate buying, appraisal, inspection, termite inspection, title, escrow, etc. The number of mortgage and real estate services used by the customer may increase the amount of discounts available to the customer.

Another advantage may be that customers may retrieve their rewards online and somewhat instantaneously, thereby saving time and money. Furthermore, the team members may be able to utilize the system to print out flyers, to recruit rewards providers and induce customers to utilize the system.

With the flyers, the team leader may identify the team members or rewards providers that generated the lead by use of their unique bonus code number, which is requested from the user. This may be valuable information for the team leader, and may provide a tracking system to compensate the originator of the flyer and/or new users.

Another advantage may be that teams may be setup one by one by a single individual, the team leader. The team leader is the head of the team throughout its life. Furthermore, the team leader may sell an area once it has been established, such that the business development in the area may become valuable and may be sold.

The system may include all hardware and software for gathering consumer information, notifying the team leader and team members. Furthermore, it may include all hardware and software for the rewards provider to create and activate discounts and coupons. The system may include a server and other computers linked via a network, and programming code to implement the system. The network may be a LAN, WAN, Internet or other network. The programming code may be Java script, HTML, or other code. It will be appreciated that other hardware, software, and types of hardware and software may be utilized, as desired.

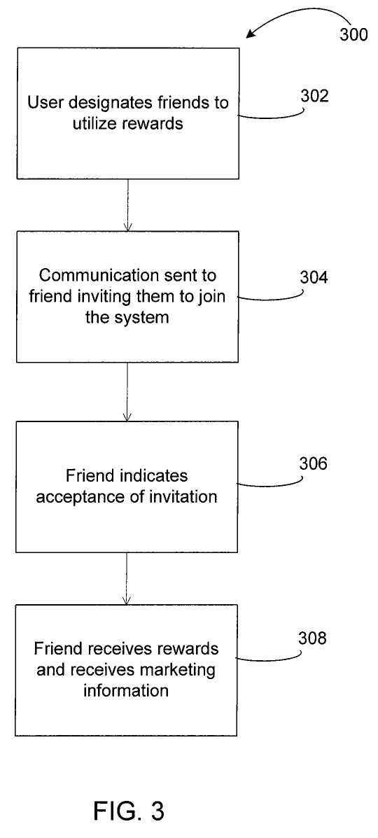

FIG. 3 may show a block diagram of a method 300 for users to include others (“friends”) in the system. Users may include individuals, team leaders, and/or others with access to the system. Friends may include other businesses, employees of the team leader and/or rewards providers, and/or individuals who know individuals receiving rewards through the program.

In an embodiment, method 300 may include a user designating a friend for inclusion in the marketing a rewards system, such that after activation the friend may have access to the rewards, as well as other aspects of the system. Part of the designation of the friend may be inclusion of an email address of the friend.

Method 300 may also include sending a communication, such as an email, to the friend inviting them to join. The friend may indicate their willingness to join by accepting the invitation 306. To utilize the rewards, the friend may receive marketing information, such as through their email. Once the friend has accepted the invitation to join the system, the friend may then have access to the rewards 308, and may utilize them at their leisure.

In an embodiment, the system may include a reseller program, which may allow team leaders within the system to invite other team leaders to join the system. The referring team leaders may be given a bonus code to provide to invited team leaders, such that the referring team leader to the system may be identified. The referring team leader may then be compensated when the referred team leader pays a fee to use the system. The referred team leader may include businesses competing with the referring team leaders. The referring team leader may make money, without doing anything, when a competitor uses the system.

In an embodiment, a business signed up by a team leader may recruit other team leaders to receive compensation from when the referred team leader pays to use the system. The business may also become a rewards provider for the referred team leader, after discontinuing to be a rewards provider for the original referring team leader.

This viral-type and/or exponential marketing may allow a relatively large amount of expansion of the marketing system. The more users of the system, the more users may likely join, based at least in part upon the number and/or types of rewards offered. Furthermore, team leaders and other users may be more likely to join a system with a large number of potential customers. Furthermore, businesses may be more likely to invite other businesses to join if there is compensation involved.

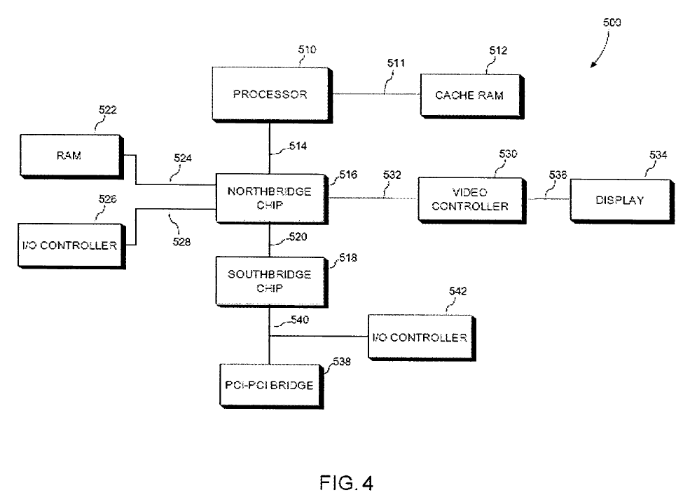

Referring now to FIG. 4, a block diagram of a computing platform capable of executing market and rewards in accordance with one or more embodiments will be discussed. It should be noted that computing platform 500 of FIG. 4 is merely one type of computing platform, and other computing platforms having more and/or fewer components than shown in FIG. 4 may be implemented, and the scope of claimed subject matter is not limited in this respect. In one or more embodiments, computing platform 500 may be utilized to implement processes 100, 200, and/or 300 in whole and/or using more and/or fewer blocks than shown in FIGS. 1, 2, and/or 3, and the scope of claimed subject matter is not limited in this respect. Computing platform 500 may include processor 510 coupled to cache random access memory (RAM) 512 via back side bus 511. Processor 510 may also couple to a chipset that includes Northbridge chip 516 via front side bus 514, and also to Southbridge chip 518 via bus 520. In one embodiment, Northbridge chip 516 in general may be utilized to connect a processor to memory, to an input/output bus, to a video bus, and to Level 2 cache, although the scope of claimed subject matter is not limited in this respect.

In one embodiment, Southbridge chip 518 may be utilized to control input/output functions, the basic input/out system (BIOS), an interrupt control functions of Integrated Drive Electronics (IDE) devices such as hard disks or compact disk-read only memory (CD-ROM) devices or the like, although the scope of claimed subject matter is not limited in this respect. Random access memory (RAM) 522 may couple to Northbridge chip 516 via main memory bus 524, and input/output (I/O) controller 526 may also couple to Northbridge chip 516 via I/O bus 528. In one embodiment, I/O controller 526 and I/O bus 528 may be in compliance with a Small Computer Systems Interface (SCSI) specification such as the American National Standards Institute (ANSI) X3.131-1994 SCSI-2 specification, although the scope of claimed subject matter is not limited in this respect. In an alternative embodiment, I/O controller 526 and I/O bus 528 may be in compliance with a Peripheral Component Interconnect (PCI) bus, although the scope of claimed subject matter is not limited in this respect.

Video controller 530 may couple to Northbridge chip 516 via video bus 532, which in one embodiment may comprise an Accelerated Graphics Port (AGP) bus, although the scope of claimed subject matter is not limited in this respect. Video controller 530 may provide video signals to an optionally coupled display 534 via display interface 536, which in one embodiment may comprise a Digital Visual Interface (DVI) in compliance with a standard promulgated by the Digital Display Working Group, although the scope of claimed subject matter is not limited in this respect. Southbridge chip 518 may couple to a peripheral component interconnect to peripheral component interconnect (PCI-PCI) bridge 538 via input/output bus 540, which may in turn couple to I/O controller 542 to control various peripheral devices such as Universal Serial Bus (USB) devices, or devices compatible with an Institute of Electrical and Electronics Engineers (IEEE) 1394 specification, although the scope of claimed subject matter is not limited in this respect.

It will be appreciated that, although this system has been described for a real estate, mortgage, and/or refinancing transaction, this system may be utilized by virtually any business to increase business leads and to further encourage consumers to use the services of a business or group of businesses, as desired.

Although the claimed subject matter has been described with a certain degree of particularity, it should be recognized that elements thereof may be altered by persons skilled in the art without departing from the spirit and/or scope of claimed subject matter. It is believed that the subject matter pertaining to market rewards systems and methods and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

In closing, it is to be understood that the embodiments described herein are illustrative of the principles of the embodiments. Other modifications that may be employed are within the scope of this disclosure. Thus, by way of example, but not of limitation, alternative configurations may be utilized in accordance with the teachings herein. Accordingly, the drawings and description are illustrative and not meant to be a limitation thereof.

What is claimed is:

1. A method for generating business leads and/or offering rewards, comprising:
referring a prospect, by a user, to join a marketing and/or rewards system; and
allowing the friend to utilize the system, based at least in part upon the prospect receiving marketing information.

2. The method according to claim 1, further comprising inviting the prospect to join the system.

3. The method according to claim 1, wherein allowing the prospect to utilize the system comprises allowing creation and management of a marketing program.

4. The method according to claim 1, wherein allowing the prospect to utilize the system comprises providing access to rewards of the system.

5. The method according to claim 4, wherein the rewards comprises bonus dollars.

6. The method according to claim 1, wherein the prospect comprises an individual and/or a business.

7. The method according to claim 1, wherein the user comprises an individual and/or business authorized to use the system.

8. The method according to claim 1, wherein the user comprises a team leader.

9. A computer program product having instructions that, if executed by a computing platform, result in generating business leads and/or offering rewards by:
referring a prospect, by a user, to join the system;
inviting the prospect to join the system; and
allowing the prospect to utilize the system.

10. The computer program product according to claim 9, wherein allowing the prospect to utilize the system comprises allowing creation and management of a marketing program.

11. The computer program product according to claim 9, wherein allowing the prospect to utilize the system comprises providing access to rewards or the system.

12. The computer program product according to claim 9, wherein the prospect comprises an individual and/or a business.

13. The computer program product according to claim 9, wherein the user comprises team leader.

14. The computer program product according to claim 13, further comprising compensating the team leader based at least in part upon a user paying to utilize the system.

15. A system for marketing and/or rewards, comprising:
means for referring a prospect, by a user, to join the system; and
means for allowing the prospect to utilize the system.

16. The system according to claim 15, wherein the means for allowing the prospect to utilize the system comprises allowing creation and management of a marketing program.

17. The system according to claim 15, wherein the means for allowing the prospect to utilize the system comprises providing access to rewards of the system.

18. The system according to claim 15, wherein the prospect comprises an individual and/or a business.

19. The system according to claim 15, wherein the user comprises an individual and/or business authorized to use the system.

20. The system according to claim 15, further comprising means for compensating the user based at least in part upon a number of referred users paying to utilize the system.
